(19) United States
(12) Patent Application Publication
(10) Pub. No.: US 2006/0237415 A1
(43) Pub. Date: Oct. 26, 2006

(54) Device for regulating the temperature of a heating wire with few emitted disturbances

(76) Inventor: Joel Choisnet, Naveil (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/539,739

(22) PCT Filed: Dec. 17, 2003
(86) PCT No.: PCT/EP03/51036

§ 371 Date: Jun. 19, 2006

(51) Int. Cl. H05B 3/00

(52) U.S. Cl. 219/201

(57) ABSTRACT

A device for regulating the temperature of a heating wire powered by a DC voltage is described. The invention has a particular, but not exclusive, utility in the de-icing of aerodynamic probes used in aeronautics. The device comprises an electronic switch connected in series with the heating wire and means for controlling the electronic switch. The device also comprises means for controlling a switching time of the electronic switch.

The invention relates to a device for regulating the temperature a heating wire powered by a DC voltage. The invention has a particular, but not exclusive, utility in the de-icing of aerodynamic probes used in aeronautics. De-icing of probes is necessary in high-altitude phases of flight during which the outside temperature is well below 0° C. The de-icing process is normally carried out by means of a heating wire disposed within the body of the probe. By making an electric current flow through the wire, the probe is warmed up, thus preventing the formation of ice on the probe which is able to modify the shape of the probe and, consequently, its aerodynamic characteristics.

A method of regulating the temperature of a probe is known from the French patent FR 2 726 148 where a heating wire whose resistance varies as a function of its temperature is used. This variation of resistance allows the temperature of the heating wire to be measured. The temperature measurement allows the electrical power supply of the heating wire to be periodically interrupted. The duty cycle, being the ratio between the time for which the power supply to the wire is present and the total duration of one period, allows the temperature of the heating wire to be regulated. In order to turn on or off the power supply to the wire, a power transistor can be used. When an AC supply line is used to power the heating wire, for example 115 VAC-400 Hz, the transistor switching can be synchronized to the times at which the power supply voltage from the line passes through zero. The interference emitted onto the line by conduction is then limited since the voltage across the terminals of the transistor is low when it switches. On the other hand, when a DC supply line is used, for example 28 VDC, the power supply voltage never passes through zero and the transistor switches high currents. For example, for a probe requiring a heating power in the range 400 to 500 W, currents of around 15 to 20 A will be switched in a very short time. The switching time of a power transistor used as an electronic switch is typically much less than 1 μs. A short switching time is advantageous from the point of view the power dissipation in the transistor; indeed, the shorter the switching time, the lower the power dissipated during switching.

Rapid variations in current drawn from the supply line cause interference to be emitted that is all the more difficult to filter the higher the powers involved.

The aim of the invention is to propose a solution to the problem of interference being emitted by avoiding switching at too high a speed in the electronic switch.

For this purpose, the object of the invention is to control the switching time of the electronic switch without affecting its actual characteristics. In other words, the subject of the invention is a device for regulating the temperature of a heating wire, the device comprising an electronic switch connected in series with the heating wire, means for controlling the electronic switch, characterized in that the device also comprises means for controlling a switching time of the electronic switch.

A consequence of the invention is an increase in the switching time of the switch which will tend to increase the power dissipated when the switch operates. The dissipated power will nevertheless be maintainable within reasonable limits with regard to the cycle time with which the switch operates.

The invention will be better understood and other advantages will become apparent upon reading the detailed description of an embodiment, presented by way of example, which description is illustrated by the appended drawing in which:

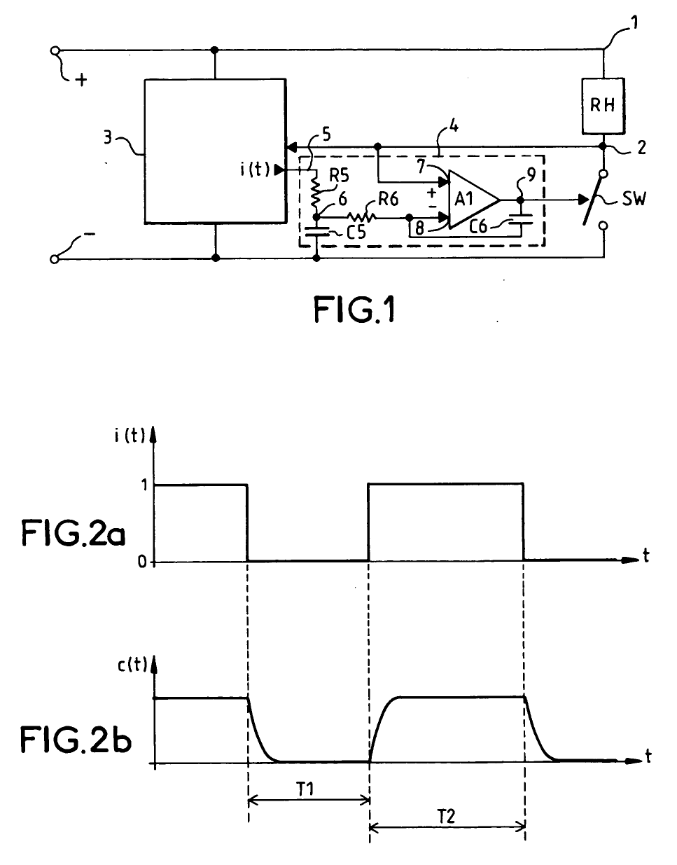

FIG. 1 shows a functional diagram of a device according to the invention;

FIGS. 2a and 2b show, in the form of a timing diagram, the control of the electronic switch placed in series with the heating wire;

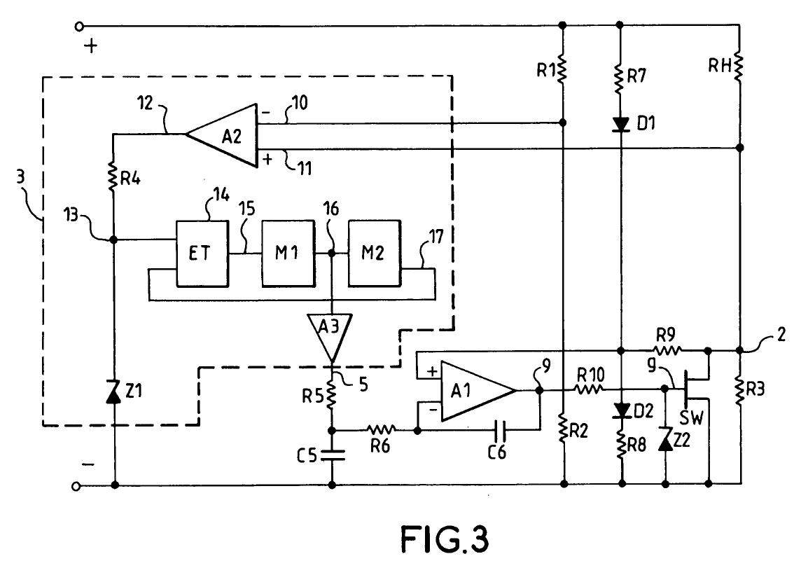

FIG. 3 shows a detailed circuit diagram of the preferred embodiment of the invention.

In order to enhance understanding of the description, the same elements will carry the same topological references in the various figures.

The device shown in FIG. 1 comprises a heating wire RH connected in series with an electronic switch SW. The assembly formed by the heating wire RH and the electronic switch SW is powered by a source of DC voltage whose positive pole is denoted + and whose negative pole is denoted −. The heating wire RH is made of a material exhibiting a non-negligible temperature coefficient that is, for example, positive. When the switch SW is closed, a current flows in the heating wire RH and the temperature of the heating wire RH can be measured by measuring the voltage present between its terminals 1 and 2. The terminal 1 is connected to the positive pole + and the terminal 2 is connected to the switch SW. The device also comprises means for measuring the temperature of the heating wire RH and means for controlling the switch SW, both shown within the box 3 so as not to overburden the functional diagram. An exemplary embodiment will be described with the aid of FIG. 3. The box 3 is connected to the terminal 2 of the heating wire RH and to the positive pole + in order to determine the temperature of the heating wire RH. The box 3 produces information i that varies as a function of time and is denoted i (t) . The inverse of the information i (t) allows the switch SW to be controlled directly when the interference emitted towards the DC voltage source is not an issue.

A timing diagram of the information i(t), which can only take two distinct values 0 and 1, is shown in FIG. 2a. 0 represents the value of i(t) for which the switch SW is closed and 1 represents the value of i(t) for which SW is open. i(t) takes the value 0 for a time T1 and the value 1 for a time T2. The time T1+T2 represents one operational cycle. The ratio T1/(T1+T2) forms the duty cycle which is modified by the means for controlling the switch SW present in the box 3 as a function of any difference that may exist between the temperature of the heating wire RH and a setpoint.

According to the invention, the device also comprises means 4 for controlling a switching time of the electronic switch SW. The means 4 comprise a resistor R5 connected to the negative pole − of the DC voltage source via a capacitor C5. A terminal 5 of the resistor R5, not connected to the capacitor C5, receives the information i(t). At the common point 6 of the resistor R5 and of the capacitor C5, there appears a setpoint voltage c(t) which is shown in FIG. 2b. When a falling edge appears on the information i(t), the setpoint voltage c(t) follows this edge with a more slowly decreasing slope than that of the edge. The rate of decrease is defined by the values of the resistor R5 and of the capacitor C5. This rate determines the switching time of the electronic switch SW. This is also the case when a rising edge appears on the information i(t) and the setpoint voltage c(t) follows this edge with a slower rate of rise than that of the edge.

The resistor R5 and the capacitor C5 form a first-order filter. It is of course possible to choose other types of components to form a first filter or even to produce a higher-order filter in order to match the time variation of the setpoint voltage c(t) to the requirements.

The switching time, defined by the values of the resistor R5 and of the capacitor C5, is longer than the normal switching time of the electronic switch then in isolation. More precisely, when a field-effect transistor, for example, is used as the electronic switch SW, the switching time of such a transistor taken in isolation is of the order of a hundred nanoseconds. In order to reduce the emitted interference, the switching time can be increased to a value, for example, of the order of a millisecond. Increasing the switching time also increases the power dissipated by the switch SW when it switches. This increase will be acceptable if the cycle time T1+T2 remains much greater than the switching time. Thus, the electronic switch will be able to dissipate the power generated when it switches, during the time periods T1 or T2 following the corresponding switching actions.

Advantageously, the control means 4 control the voltage across the terminals of the switch SW as a function of the setpoint voltage c(t). More precisely, still in the example of a field-effect transistor used as the electronic switch SW, it is observed that controlling the gate voltage does not allow the power dissipated by the transistor to be controlled with a high degree of precision. It is preferable to control the voltage between the source and the drain of the transistor which allows the current flowing through the transistor, and hence the power that is dissipated within it, to be controlled. In order to achieve this control, the control means 4 comprise for example an operational amplifier A1, whereof a first input, the non-inverting input 7, is connected to the common point 2 of the heating wire RH and of the electronic switch SW and whereof a second input, the inverting input 8, receives the setpoint voltage c(t). The operational amplifier A1 also comprises an output 9 that controls the turning-on or turning-off of the electronic switch SW. The operational amplifier A1 compares the voltage present at the common point 2 with the setpoint c(t). The operational amplifier A1 controls the switch SW so that the voltage present at the common point 2 remains continuously, and especially during the switching actions, equal to the setpoint c(t). A resistor R6 can be provided connected between the terminal 6 and the inverting input 8 together with a capacitor C6 connected between the inverting input 8 and the output 9 of the operational amplifier A1. The capacitor C6 and the resistor R6 ensure the stability of the control. Their values allow a time constant, which is for example of the order of one microsecond, to be determined.

FIG. 3 shows a detailed circuit diagram of one embodiment of a temperature regulation device whose functional configuration has been described with the aid of FIG. 1.

In box 3, a comparator A2 allows the temperature of the heating wire RH to be compared with a setpoint temperature. More precisely, an inverting input 10 of the comparator A2 is connected to the common point of two resistors R1 and R2 connected in series between the positive pole + and the negative pole − of the DC voltage source. A non-inverting input 11 of the comparator A2 is connected to the common point of the heating wire RH and of a resistor R3 connected in parallel with the electronic switch SW. The heating wire RH and the resistor R3 are connected in series between the positive pole + and the negative pole −. The heating wire RH and the three resistors R1, R2 and R3 form a Wheatstone bridge whose imbalance is detected by the comparator A2. The common point of the resistors R1 and R2 forms a reference voltage that represents the setpoint temperature. By choosing a heating wire RH whose resistance varies as a function of temperature, it is possible to determine by means of the comparator A2 if the temperature of the heating wire is higher or lower than the setpoint temperature. The operation to measure the temperature of the heating wire RH is carried out when the switch SW is open. The value of the resistor R3 is chosen such that, when the electronic switch SW is open, only a low current flows in the heating wire RH and in the resistor R3. For example, the value of the resistor R3 is five-hundred times higher than the average value of the reistance of the heating wire RH.

The resistance of the heating wire RH exhibits, for example, a positive temperature coefficient. The values of the resistors R1 and R2 are chosen such that, when the Wheatstone bridge is balanced, the temperature of the heating wire RH is equal to the setpoint temperature. In the case where the temperature coefficient of the heating wire RH is positive, if the temperature of the heating wire RH is higher than the setpoint temperature, a voltage present at an output 12 of the comparator A2 is close to the voltage of the negative pole −. On the other hand, if the temperature of the heating wire RH is lower than the setpoint temperature, the voltage present at the output 12 is then close to the voltage of the positive pole +. The voltage present at the output 12 can be adapted by means of a resistor R4 and of a Zener diode Z1 both connected in series between the output 12 and the negative pole. The anode of the Zener diode Z1 is directly connected to the negative pole −. At a point 13, the cathode of the Zener diode Z2 is connected to the resistor R4. Furthermore, the point 13 forms an input of an AND cell 14 whereof an output 15 forms an input of a monostable circuit M1. An output 17 of the monostable circuit M1 forms the input of a monostable circuit M2. An output 16 of the monostable circuit M2 forms a second input of the AND cell 14. The signal i(t) is present at the output 16 of the monostable circuit M1.

When the electronic switch SW is open and the temperature of the heating wire RH falls below the setpoint temperature, the voltage at the output 12 of the comparator A2 rises and the monostable circuit M1 delivers a pulse of value 0, of fixed duration T1, for example of the order of 500 ms, for the signal i(t) at the output 16, when a rising edge appears at the output 15 of the AND cell 14. As has been seen previously by means of FIG. 1, during the pulse of value 0 for the signal i(t), the switch SW is made to conduct and the heating wire RH is powered by a high current allowing it to heat up. At the end of the pulse of value 0 for the signal i(t), the monostable circuit M2 delivers a negative pulse of a minimum duration T2, for example of the order of 5 ms, at the output 17, making the switch SW open and allowing the temperature of the heating wire RH to be measured. As long as the temperature of the heating wire RH remains higher than the setpoint temperature, the voltage present at the output 12 of the comparator A2 remains at its lowest level and the negative pulse continues. On the other hand, when the temperature of the heating wire RH falls below the setpoint temperature, the AND cell 14 allows a new positive pulse to appear. In sum, the heating wire RH is heated during a pulse of fixed duration T1 and each pulse of duration T1 is followed by a time T, at a minimum equal to T2, during which the heating is interrupted. The time T1 is constant and is fixed by the monostable circuit M1, whereas the time T depends on the temperature of the heating wire RH. The minimum duration T2 of the duration T is fixed by the monostable circuit M2. The duration T remains equal to the duration T2 as long as the temperature of the heating wire RH is lower than the setpoint temperature.

The voltage level of the signal i(t) present at the output 16 may need to be adapted. For this case, an amplifier A3 is provided that receives the signal i(t) present at the output 16 and that delivers a signal proportional to the signal i(t) at terminal 5 of the resistor R5.

The electronic switch SW is advantageously a field-effect transistor whereof a gate g receives the signal present at the output 9 of the amplifier A1 via a resistor R10. A cathode of a Zener diode Z2 is connected to the gate g and an anode of the Zener diode Z2 is connected to the negative pole −. The resistor R10 and the Zener diode Z2 allow the voltage of the signal present at the output 9 of the amplifier A1 to be adapted to the requirements of the field-effect transistor.

Advantageously, if the output voltage of the signal present at the output 9 does not reach the voltage of the negative pole −, or that of the positive pole +, resistors R7, R8 and R9, together with diodes D1 and D2, can be provided in order to ensure a correct control of the voltage between the drain and the source of the transistor or, in other words, of the voltage across the terminals of the electronic switch SW. The resistor R9 is connected between the point 2 and the non-inverting input 7 of the amplifier A1. The resistor R7 and the diode D1 are connected in series between the positive pole + and the non-inverting input of the amplifier A1. The resistor R8 and the diode D2 are connected in series between the non-inverting input of the amplifier A1 and the negative pole −. Diodes D1 and D2 are oriented such that a current flows through them from the positive pole + toward the negative pole −.

1. A device for regulating the temperature of a heating wire, the device comprising:
an electronic switch connected in series with the heating wire,
means for controlling the electronic switch,
wherein the device also comprises means for controlling a switching time of the electronic switch and in that the control means control the voltage across the terminals of the switch as a function of a setpoint voltage defining the switching time.

2. The device as claimed in claim 1, comprising: means for measuring the temperature of the heating wire, wherein the control means turn the electronic switch on and off as a function of the temperature of the heating wire.

3. The device as claimed in claim 2, wherein the means for measuring the temperature of the heating wire comprise means for comparing the voltage present at the common point between the electronic switch and the heating wire with a reference voltage.

4. The device as claimed in claim 1, wherein the control means define a switching time that is longer than the normal switching time of the electronic switch taken in isolation.

5. The device as claimed in claim 1, wherein the control means comprise an operational amplifier, whereof a first input is connected to the common point of the heating wire and of the electronic switch, whereof a second input receives the setpoint voltage and whereof the output controls the turning-on and the turning-off of the electronic switch.

6. The device as claimed in claim 2, wherein the control means define a switching time longer than the normal switching time of the electronic switch taken in isolation.

7. The device as claimed in claim 3, wherein the control means define a switching time longer than the normal switching time of the electronic switch taken in isolation.

8. The device as claimed in claim 2, wherein the control means comprise an operational amplifier, whereof a first input is connected to the common point of the heating wire and of the electronic switch, whereof a second input receives the setpoint voltage and whereof the output controls the turning-on and the turning-off of the electronic switch.

9. The device as claimed in claim 3, wherein the control means comprise an operational amplifier, whereof a first input is connected to the common point of the heating wire and of the electronic switch, whereof a second input receives the setpoint voltage and whereof the output controls the turning-on and the turning-off of the electronic switch.

10. The device as claimed in claim 4, wherein the control means comprise an operational amplifier, whereof a first input is connected to the common point of the heating wire and of the electronic switch, whereof a second input receives the setpoint voltage and whereof the output controls the turning-on and the turning-off of the electronic switch.
